(19) United States
(12) Patent Application Publication
(10) Pub. No.: US 2016/0155114 A1
(43) Pub. Date: Jun. 2, 2016

(54) Smart communication device secured electronic payment system

(71) Applicants: Kevin S. Kerridge, Maitland, FL (US); James Gillen, Thomhill (CA)

(72) Inventors: Kevin S. Kerridge, Maitland, FL (US); James Gillen, Thomhill (CA)

(21) Appl. No.: 14/998,659

(22) Filed: Jan. 28, 2016

Related U.S. Application Data
(63) Continuation of application No. 13/506,762, filed on May 16, 2012.
(60) Provisional application No. 61/457,712, filed on May 17, 2011.

(51) Int. Cl. G06Q 20/32; G06Q 20/38; G06Q 20/40; G06Q 20/20; G06Q 20/34

(52) U.S. Cl. CPC G06Q 20/3278; G06Q 20/202; G06Q 20/34; G06Q 20/409; G06Q 20/385

(57) ABSTRACT

Systems, apparatuses, and methods enabling secure payment transactions, and methods for sharing secure documents, via a mobile device, for example a mobile telephone, smartphone, cellular telephone, other wireless device, a Near Field Communications (NFC) device, or the like. Actual user account information is substituted with temporary account information such that the temporary account information may be manipulated in a manner similar to actual user account information, with the result that actual account information is masked thereby greatly reducing the likelihood of misuse.

### RELATED APPLICATIONS

This is a continuation application claiming priority from U.S. patent application Ser. No. 13/506,762, filed May 16, 2012 and the benefit of U.S. Provisional Application No. 61/457,712, filed May 17, 2011.

### STATEMENT REGARDING FEDERALLY SPONSORED RESEARCH OR DEVELOPMENT

Not applicable.

### REFERENCE TO SEQUENCE LISTING, A TABLE, OR A COMPUTER PROGRAM LISTING COMPACT DISC APPENDIX

None.

### FIELD OF THE INVENTION

The present invention and its embodiments generally relate to systems, apparatuses, and methods enabling secure commercial transactions, for example, secure payment transactions facilitated via a mobile device, for example a mobile telephone, smartphone, cellular telephone, other wireless device, or a Near Field Communications (NFC) device, or the like, for example a Radio Frequency Identification (RFID) device or Bluetooth device. The invention is also directed toward systems, apparatuses, and methods for sharing secure documents via the same mobile devices. More specifically, the systems and methods of the present invention provide an additional layer of security with respect to the aforementioned transactions whereby actual user account information is substituted with temporary account information so that the temporary account information may be manipulated in a manner similar to actual user account information, with the result that actual account information is masked thereby greatly reducing the likelihood of misuse.

### BACKGROUND OF THE INVENTION

Portable wireless devices carried by consumers are quickly becoming ubiquitous. Mobile telephones (in particular smart communications devices or smartphones), tablet computers, Personal Digital Assistants (PDAs) and the like are being carried daily by ever-increasing numbers of people. These devices are being used to perform a wide variety of tasks, such as standard voice communications, e-mail access, Internet access, and a host of other activities. More recently, interest has increased with regard to use of a portable wireless device in lieu of a payment card, for example a credit card or debit cart. In addition to the standard elements and capabilities of a cellular phone, these devices typically contain additional elements capable of storing a user's payment card information, such as their credit card account number. This additional element is further tied in with near field communications (NFC) technology, or the like, for example Radio Frequency Identification (RFID) to facilitate transmission of the account number over a short range to a contactless reader.

Contactless readers are becoming commonplace in the market as a replacement for standard payment card readers. Unlike a card reader, whose operation involves a merchant or the consumer physically sliding the payment card through or into the card reader in order for the payment card account information to be read, a contactless reader retrieves the payment card information from the device through the use of a short range radio transmission, such as those used in RFID. The device need only be held in the vicinity of the contactless reader. In the United States, Visa®, Inc. (payWave®), MasterCard® Worldwide (PayPass®), and American Express® (ExpressPay®) issue credit cards whereby the user simply waves her card within 4 inches of a terminal with the result that payment account information is wirelessly transferred to the seller for processing the transaction.

Although the use of contactless card readers increases user convenience, this technology also presents a number of disadvantages. Due to the wireless nature of the contactless reader, it is possible that the contactless reader may be used for surreptitious interrogation of the portable wireless device by intercepting the portable wireless device's communications. In addition, a contactless reader could be developed or modified to enhance its power and sensitivity to thereby interrogate a consumer's card and/or smart device surreptitiously.

Theft of sensitive information, such as an account number, using wireless interrogation or interception of communications from portable wireless device is a major concern for consumers and businesses alike. Unfortunately, given the sophistication of the wireless interrogation equipment and the nature of wireless signals, it is easy for wireless interrogation to occur at virtually any time and place. Once the victim of fraudulent wireless interrogation discovers that sensitive information has been stolen, it is often too late to discover where the theft took place. The victim must then deal with the consequences and inconvenience of correcting the unauthorized access and possible misuse of the information and any credit problems which result from such theft.

In response to such risks, many payment service providers have instigated safeguards for protecting purchases from fraudulent attacks, for example, by employing encryption technologies to encrypt the payment account number and other data associated with account transactions.

Encryption generally involves encrypting transaction data on one end of a transmission with a key, and then regenerating the original transaction data by decrypting the encrypted data received with the same key on the other end of the transmission. While encryption technologies have proven to be highly effective in preventing information theft, implementing or upgrading to the latest encryption technology often requires upgrades by the end users of payment processing networks. Due to the cost, time, and risk of potential business interruption (e.g., loss of sales), merchants resist making necessary upgrades to their procedures and systems to implement such safeguards. Therefore, such safeguards achieve limited success as they are generally expensive to implement, can be overcome, are susceptible to constantly improving technology for breaking encryption and have not been fully accepted by the credit card industry, merchants, payment processors, etc.

In the case of a portable wireless device, for example the smartphone, it may be possible to require some type of code, such as a Personal Identification Number (PIN) to be entered prior to enabling the short range wireless transmission element. Although this may partially resolve the issue of the wireless transmission being intercepted while the user is not actively using the device, it does not resolve situations where the sensitive information is intercepted while the user is making a legitimate purchase and has thus already entered the PIN. What are needed are cost effective devices and/or methods that integrate easily with existing payment processing networks and prevent unauthorized access to user account information.

### SUMMARY OF THE INVENTION

The present invention includes apparatuses and/or methods for preventing fraud with regard to the use of mobile devices, for example a smartphone or similar communications device (SD), for payment transactions. The invention provides a layer of security for near field communications (NFC) from a mobile telephone or other wireless device for payment transactions and/or sharing secure documents by substituting actual users' account information with Trojan Horse account information so that real identity and account information is cloaked behind proxy hardware, software, or a combination thereof insulating the user (account holder) from fraudulent activity. This security minimizes the likelihood of liability to the wireless provider/manufacturer regarding the transaction. The account holder may choose to make a live payment decision among several accounts (i.e., credit, debit, savings), with or without spending limits, at the time of the transaction. The account holder's information and identity will have been previously authenticated and registered on security intermediation service provider (SISP) hardware, software, or a combination thereof, allowing secured and authenticated e-signatures and Identity Assured PIN Pad Present Signing. Additionally, it is noted that this increased level of security obviates the spending limits currently imposed with regard to NFC payment transactions. Accordingly, payment ceilings, typically approximately $100, imposed by payment card issuers will no longer need to be enforced.

The invention additionally contemplates a mobile telephone or other wireless device repeating the payment information and generating a single use barcode for scanning by a point-of-sale (POS) terminal such that the bar code expires subsequent to its use in a payment authorization. Moreover, each SISP-facilitated transaction is unique and neither repeats nor replays transaction data with the result that photographing or otherwise memorializing/copying transaction data for subsequent use will be ineffective.

This invention further contemplates generalized utility beyond near field communications (NFC) to include use of smartphones or similar smart communications devices (SD) with a supplied software application or, with regard to a smart chip card, a cache of codes to participate in secure electronic payments using masked proxy account numbers (PAN) and proxy name fields (PNM) via a security and transaction acceptance intermediary (i.e., SISP) that forwards unmasked transactions for authorization and payment.

It is an object of the invention to provide secure payment transactions facilitated via a mobile device, for example a mobile telephone, smartphone, cellular telephone, or other wireless device, a near field communications (NFC) device, or the like;

It is another object of the invention to provide secure payment transactions facilitated via a smart chip card; and,

It is yet another object of the invention to facilitate secure file transfer.

The invention will be better understood and objects other than those set forth above will become apparent when consideration is given to the following detailed description thereof. Such description makes reference to the annexed drawings.

### BRIEF DESCRIPTION OF THE DRAWINGS

FIG. 1 is a schematic representation of the invention utilizing a mobile telephone or similar smart device.

FIG. 2 is a detailed alternative depiction of the invention shown in FIG. 1.

FIG. 3 is a schematic representation of a third embodiment.

### DETAILED DESCRIPTION OF THE INVENTION

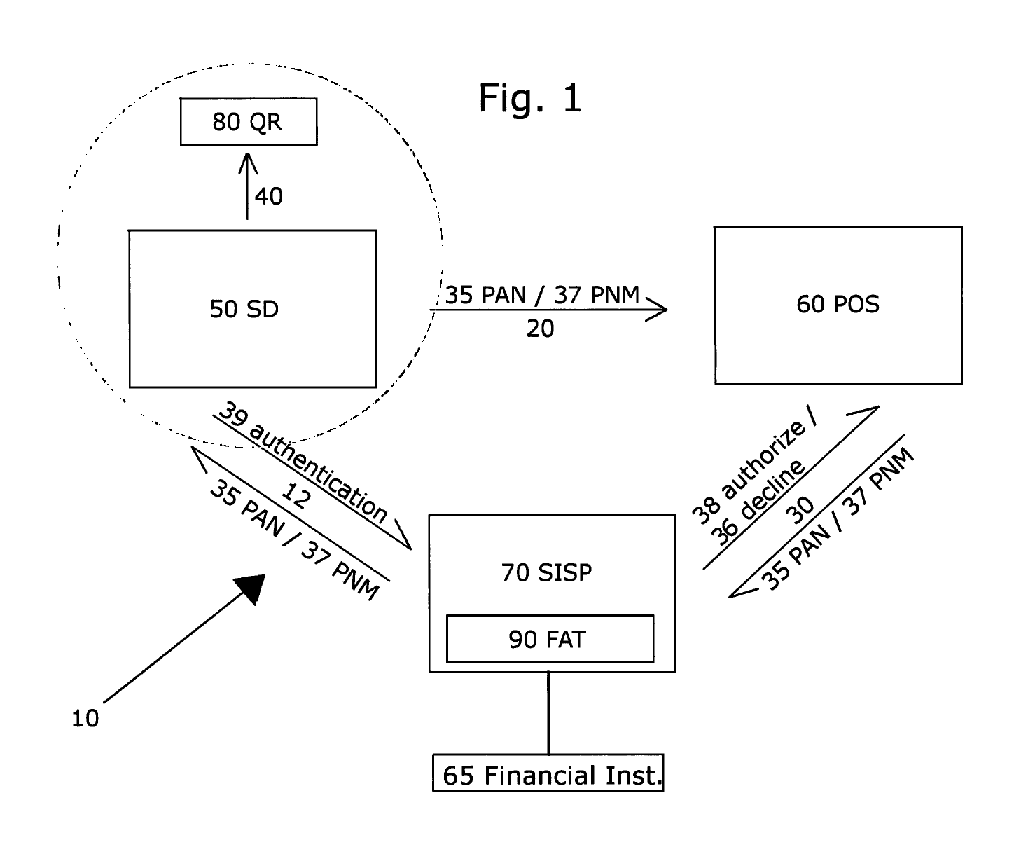

The preferred embodiments and best mode of the invention is shown in FIG. 1. While the invention is described in connection with certain preferred embodiments, it is not intended that the present invention be so limited. On the contrary, it is intended to cover all alternatives, modifications, and equivalent arrangements as may be included within the spirit and scope of the invention as defined by the appended claims.

As shown in FIG. 1, the present invention 10 includes proxy information comprising a proxy account number (PAN) 35 and proxy name field (PNM) 37; a smart device (SD) 50; a point-of-sale terminal (POS) 60; and security intermediation service provider (SISP) 70 hardware, software, or combination thereof. The invention 10 can use any communications protocol, including near field communications (NFC), radio frequency identification (RFID), Bluetooth, or similar local, or Internet network communications protocol, network, service, or the like

The proxy account number (PAN) 35 is a limited validity payment card number fulfilling the requirements for a valid number for a selected payment card type (such as debit card, credit card) and includes an individual identification number (IIN) (not depicted) routing to the SISP 70 and identifying to the SISP 70, a specific SD 50 and hence a cardholder for unmasking the true account number and name. Similarly, the PNM 37 is a limited validity encrypted string of 26 characters that substitutes for the 26 character name field used on payment cards. The PAN 35 is a temporary account number that is functionally equivalent to an ordinary account number with regard to its use by retailers, etc. at, for example, a POS 60, but has no direct association with a payment card. The PAN 35 looks like and routes to the SISP 70 like an ordinary account number but has no direct association with a cardholder and utilizes encrypted tokens in lieu of names. The PAN 35 and encrypted tokens are stored securely in the smart device (SD) 50 and are periodically downloaded by the SISP 70. They have limited validity and cannot be copied and reused.

In operation, in a first step 12, a cardholder and the associated SD 50 is registered with a SISP 70 and the payment card types (and associated account information) to be associated with the SD 50 are authorized by the cardholder (not shown). To further prevent fraud, the cardholder is authenticated 39 via the SD 50 using, for example, biometric indicia such as a fingerprint, facial recognition, signature authentication, or other individual identifying characteristic that may be discerned using, for example, the camera that is now ubiquitously incorporated into all SD 50 apparatuses. Periodically thereafter, after local cardholder authentication 39 (using, for example, biometrics and a password), the SD 50 communicates with the SISP 70 using secure internet protocols and the SISP 70 generates and sends a PAN 35, PNM 37, and any other necessary information that will subsequently be used by the SD 50 for electronic payments. The PAN 35 and PNM 37 expire upon use during an electronic payment transaction or may automatically expire within a defined time interval of non-use.

In a second step 20, a payment operation may be made at a POS 60 using the SD 50 wherein a PAN 35 and PNM 37 obtained from the SISP 70 is used in an electronic payment transaction. The PAN 35 and PNM 37 function as a normal payment card in all respects except that cardholder personal information (actual account number and name) are masked. The electronic payment using the PAN 35 and PNM 37 is initiated and controlled by a software application on the SD 50 so that the payment transaction is first communicated to the SISP 70 in order to validate the PAN 35 and PNM 37. In a following step 30, the SISP 70 unmasks the associated account information (e.g., account holder number, name, etc.), and forwards the payment authorization 38 to the POS 60, or in instances of insufficient funds, suspected fraud, etc., declines the transaction 36.

In cases where the SISP 70 resides at a financial institution 65, authorization occurs at the institution. Alternatively, where the SISP 70 is hosted offsite, the information is forwarded to the financial institution 65 for authorization as would be understood by one skilled in the art.

Note that when a cardholder authorizes a payment using one of the card types registered on the SD 50, the SD 50 randomly selects a PAN 35 and PNM 37 from its local cache. The PAN 35 and PNM 37 are neither serially assigned nor duplicated and thereby defeat local reuse by unauthorized third parties. Selection can be further constrained through configuration of the SD 50 by the SISP 70 to be sensitive to geo-location, device characteristics, biometrics and passwords used on the SD 50. Moreover, the SD 50 need not be in communication with the SISP 70 in order to use the SD 50 to make an electronic payment because it maintains a local cache of PAN 35, PNM 37, and other information necessary for a payment card transaction. Additionally, inadvertent or fraudulent duplicate use of the selected PAN 35 and PNM 37 are prevented by the SISP 70, thereby eliminating multiple charges for the same transaction. To further prevent fraud, sequential payments at the same merchant within defined location and time parameters require that the card holder cause the SD 50 to randomly select a new PAN 35/PNM 37 pair from its secure local cache.

With particular regard to a mobile telephone or similar SD 50, in an optional step 40, the device (SD 50) may additionally create a quick response code (QR Code) 80 containing a URL reference to data about the transaction stored at and supplied by the SISP 70, for example, amount, time, date, POS or store number, the GPS location of the device, and any other information available which may be included by the URL in the QR Code to facilitate a complete audit trail which is accessible via this URL from the SISP 70 using secure internet protocols. In addition the merchant can use the (QR Code) 80 directly in the POS 60 to independently confirm payment directly with the SISP 70.

Electronic payment using the SD 50 can be via NFC, RFID, Bluetooth, or similar local, or Internet network communications service and a POS 60 or similar merchant device, terminal, system, or service; or via payment instructions sent from the SD 50 to the SISP 70 by any means of communications including secure email.

To ensure security, the PAN 35 and PNM 37 are randomly selected by the SD 50 from its secure local cache. The selection of PAN 35 and PNM 37 is serially unique thereby minimizing fraud through replay attacks, copy, broadcast, reuse, and the like. When an electronic payment is received by the SISP 70, it uses PAN 35, PNM 37 and other transaction details, for example location information, timestamps, merchant information, purchase amount, SD 50 characteristics, network characteristics, digital images and any other data available for security validation (authentication, authorization, fraud control, AML/ATF control, etc.) to ascertain transaction uniqueness. If security validation and uniqueness tests are passed, the unmasked account information 38 (i.e., account number and name fields associated with the card type registered by the cardholder with the SISP 70) is used for payment authorization and the authorization or denial is then forwarded to the POS 60 in a manner as would be understood by one skilled in the art.

A forensic audit trail (FAT) 90 is maintained by the SISP 70 of all transaction stages and results in an online accessible repository available in whole or in part to authorized parties to the transaction, as permitted by regulations, while maintaining privacy of cardholder details to the fullest extent possible.

When the SD 50 communicates directly with the SISP 70 to submit transaction details, the SD 50 provides all information required to originate the payment transaction as required under IS08583 or the like. This information can be automatically acquired by the SD 50 using NFC, bar codes, local network communications (e.g. Bluetooth) and other means available through the SD 50. Payment instructions can be sent by the SD 50 to the SISP 70 via asynchronous or real-time communications and/or via secure email. Payment confirmation is sent by the SISP 70 to the SD 50 via asynchronous or real-time communications and/or via secure email. The payment confirmation can take many forms including a (QR Code) 80. A QR Code can be scanned by a POS 60 or similar merchant device, terminal, system, or service; to enable a merchant to confirm payment directly with the SISP 70 using secure internet protocols by use of the URL information in the QR Code. The SISP 70 periodically refreshes the secured SD 50 local cache of PAN 35, PNM 37 and other payment card details within the SD 50 subsequent to local authentication of the cardholder on the SD 50. PANs 35 and PNMs 37 have limited validity and expire upon use or after a predetermined period of non-use.

Additional transaction acceptance controls can be imposed by the SISP 70 as desired using rules supplied by cardholders, merchant acquirers, card issuers and other authorized parties to the transaction. These rules can, for example, prevent use of the SD 50 for making payments at certain times, outside of geographic boundaries, at certain merchants, above certain amounts, or above certain amounts as predetermined by the merchant, card issuer, or other parties in the retail chain. In the event payment authorization is denied, notifications may be forwarded to one or more parties to the transaction and noted in the forensic audit trail (FAT) 90 stored within the SISP 70.

Use of a quick response (QR Code) 80 created by the SISP 70 and provided by the SISP 70 to the SD 50 or the POS 60 facilitates the addition of data to the transaction, for example originating data such as amount, details of the merchant device, time, date and GPS location stamp. In this manner the FAT 90 can be enhanced with respect to the traceability of the origin of the purchase, including location and temporal information regarding the transaction. The QR Code is a URL reference to this data and can be scanned by the POS 60 or placed on the face of a check or document for subsequent scanning to obtain the URL reference within the QR Code for access to this data from the SISP 70.

SISP 70 services are typically borne by one or more parties to the transaction, and/or by fees recovered through advertising, carriers, ISPs, device manufacturers, or any party having an economic or financial interest in use of SDs with regard to electronic payments.

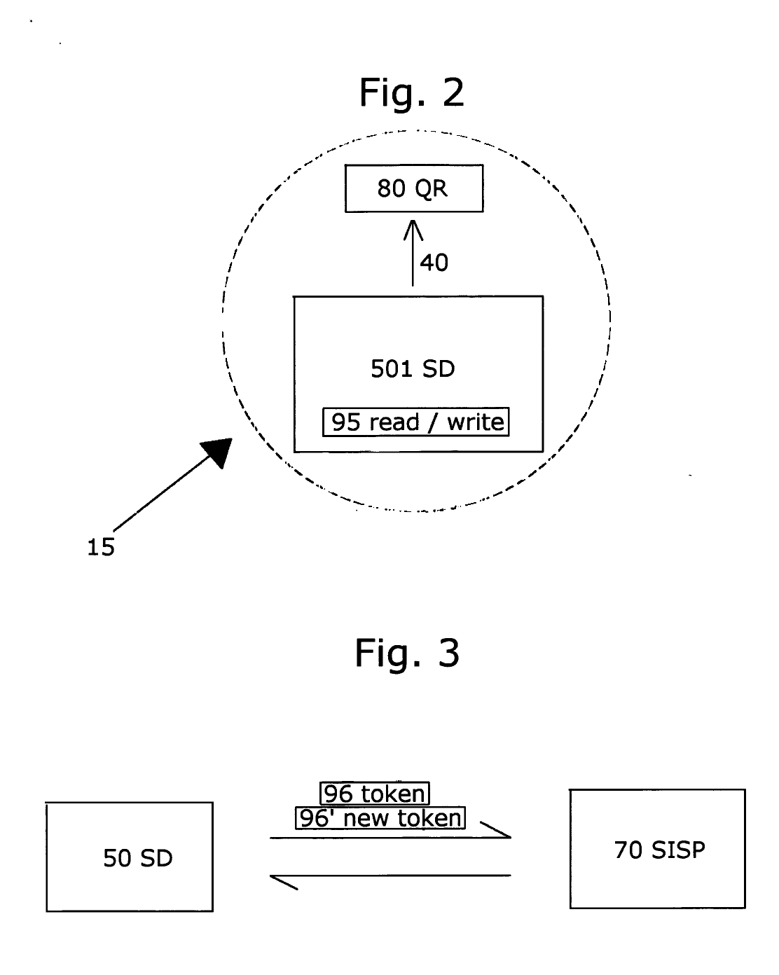

In yet another aspect of the invention, FIG. 2 shows an alternative embodiment 15 of the SD 50 component shown in FIG. 1. The alternative SD 501 includes a smart chip card reader/writer 95 whereby a smart chip payment card (not shown) is inserted into the reader/writer 95. The alternative SD 501 connects to the SISP 70 to download PAN 35 and PNM 37 information onto the smart chip payment card. The smart chip payment card (not shown) is then usable as payment card to supplement the functionality of the alternative SD 501. With specific regard to use of a smart chip payment card (not shown) or similar storage device, the PAN 35 and PNM 37 may become stale dated after a predetermined time in order to further prevent fraud. The stale dated PAN 35 and PNM 37 will not be accepted by the SISP 70 such that the card holder is required to re-authenticate themselves to the SISP 70, and fresh PAN 35 and PNM 37 tokens must be downloaded for completion of the transaction

FIG. 3 is a diagrammatic depiction whereby the SD 50 can unlock a sensitive document by sending a token 96 to the SISP 70 and unlocking the hardware encrypted file if the file resides on the SISP 70. To wirelessly retransmit the document, the user would transfer a new token 96′ for the document and when the new token 96′ was sent back for confirmation an unlock code would be sent to unlock the document on the server. For example, in sending a S/MIME attachment via email, the certificate for an application to perform encryption comes from the SISP during registration. Hence, the S/MIME facilitates other containers, each encrypted with different keys. Within one of these containers is a set of payment instructions with its own key. Within a payment instruction exists a PAN and PNM where PAN is a limited validity number (limited by data related to time of use, sequence of use, device used from, password or biometric present, location, merchant type et cetera) and PNM is an encrypted token that contains a unique number.

Any of the software components or functions described in this application may be implemented as software code to be executed by a processor using any suitable computer language such as, for example, Java, C++, Perl, or the like, using, for example, conventional or object-oriented techniques. The software code may be stored as a series of instructions or commands on a computer readable medium, such as flash memory, Random Access Memory (RAM), Read Only Memory (ROM), a magnetic medium, for example a hard drive, or an optical medium, for example a CD-ROM. Any such computer readable medium may reside on or within a single computational apparatus and may be present on or within different computational apparatuses within a system or network.

The principles, preferred embodiments and modes of operation of the present invention have been described in the foregoing specification. However, the invention should not be construed as limited to the particular embodiments which have been described above. Instead, the embodiments described here should be regarded as illustrative rather than restrictive. Variations and changes may be made by others without departing from the scope of the present invention as defined by the following claims:

1) A method for secure payment transactions facilitated via a mobile smart device comprising the steps of:
a) registering actual payment card account information of a card holder and an associated mobile smart device with a security intermediation service provider;
b) receiving proxy payment card account information from said security intermediation service provider comprising a proxy account number and a proxy name field which are stored in said mobile smart device;
c) authenticating the user identity of said mobile smart device;
d) linking said proxy payment card account information from said mobile smart device to said actual payment card account information at said intermediate service provider for payment validation;
e) commencing a payment transaction via said mobile smart device and a merchant device using said proxy payment card account information; and
f) completing said payment transaction using said actual payment card account information.

2) (canceled)

3) The method as claimed in claim 1 wherein authentication of the user's identity is accomplished using biometric information taken from a group consisting of fingerprinting, facial recognition, and signature authentication.

4) (canceled)

5) The method as claimed in claim 1 wherein said mobile smart device comprises a smart chip card reader/writer which in interaction with a smart chip card enables said smart chip card for a payment transaction.

6) (canceled)

7) A method for secure payment transactions facilitated via a mobile smart device comprising the steps of:
a) registering actual payment card account information and an associated mobile smart device with a security intermediation service provider which generates proxy payment card account information;
b) receiving proxy payment card account information comprising a proxy account number and a proxy name field downloaded to said mobile smart device from said security intermediation service provider, said proxy payment card account information being linked to and masking said actual payment card account information;
c) commencing a payment transaction via a mobile smart device and a merchant device using said proxy payment card account information;
d) authenticating the user's identity using biometric information of the user;
unmasking the associated account information and forwarding payment authorization to the point of sale;
f) completing said payment transaction using said actual payment card account information; and
g) repeating steps b)-g) for each subsequent payment transaction using a different proxy account number and proxy name file.

8) (canceled)

9) (canceled)

10) The method as claimed in claim 7 wherein said mobile device comprises a smart chip card reader/writer which in interaction with a smart chip card accomplishes said payment transaction.

11) (canceled)

12) A method for secure document delivery facilitated via a mobile device comprising the steps of:
a) sending a token from a mobile device to a security intermediation service provider, said security intermediation service provider having an encrypted document residing thereon;
b) receiving said encrypted document;
c) receiving an unlocking code from said security intermediation service provider; and
d) unlocking said received encrypted document.

13) The method as claimed in claim 12 wherein said encrypted document is a hardware encrypted document.

14) The method as claimed in claim 12 wherein said unlocking code is a proxy name field comprising an encrypted token containing a unique number.

15) The method as claimed in claim 12 wherein said encrypted document is an S/MIME attachment sent via e-mail.

16) A method for providing security for near field communications (NFC) for in person payment transactions from a mobile smart device such as a smart phone comprising the steps of:
a) registering actual payment card account information with a security intermediation service provider;
b) generating proxy payment and information correlating to said actual payment card account information in said security intermediation device and transmitting said proxy payment card information to said mobile smart device;
c) randomly selecting proxy account information from storage in said mobile smart device;
d) substituting an actual users account information registered with said security Intermediation service with temporary one time use proxy account information so that the real user identity and account information is cloaked;
e) linking said proxy payment card account to said actual payment card account information while masking said actual payment account information;
f) commencing a payment transaction via said mobile smart device and a merchant device using said proxy payment card account information; and
g) repeating steps b)-e) for each subsequent payment transaction.

17) The method as claimed in claim 16 wherein sequential payment to the same merchant on said mobile smart device are constructed to preset defined location and time parameters.

18) The method as claimed in claim 16 wherein said proxy payment card account information comprises an individual identification number and a limited validity encrypted string of 26 characters.

19) The method as claimed in claim 16 wherein said generated proxy payment card information is functionally equivalent to an ordinary discount card.

20) The method as claimed in claim 16 wherein proxy payment card information is periodically downloaded from said security intermediation provider to said mobile smart device for future use.
